(19) United States
(12) Patent Application Publication
(10) Pub. No.: US 2014/0346156 A1
(43) Pub. Date: Nov. 27, 2014

(54) Adaptive Mirror for a Laser Processing Device

(71) Applicant: LT-Ultra Precision Technology GmbH, Herdwangen-Schoenach (DE)

(72) Inventor: Dietmar Bischof, Bermatingen (DE)

(73) Assignee: LT-Ultra Precision Technology GmbH, Herdwangen-Schoenach (DE)

(21) Appl. No.: 14/282,820

(22) Filed: May 20, 2014

(30) Foreign Application Priority Data
May 21, 2013 (DE) 102013008646.9

(51) Int. Cl. G02B 26/08; B23K 26/04; G02B 7/182

(52) U.S. Cl. CPC G02B 26/0825; G02B 7/182; B23K 26/046
USPC 219/121.74; 359/846; 219/121.81

(57) ABSTRACT

An adaptive mirror for a laser processing apparatus has a housing and a pressure chamber which is arranged in the housing and can be connected to a pressure source. A mirror substrate, which delimits the pressure chamber, is fixedly clamped in the housing. Depending on the internal pressure in the pressure chamber, which can be changed by means of the pressure source, the mirror substrate is deformed. The mirror substrate has a stiffness which increases towards the geometric centre at least in a region surrounding the geometric centre of the mirror substrate. By means of such a stiffness distribution, an almost spherical deformation can be achieved over a large surface of the mirror substrate despite the mirror substrate's being fixedly clamped into the housing.

### BACKGROUND OF THE INVENTION

1. Field of the Invention

The invention relates to an adaptive mirror for a laser processing apparatus with which workpieces can be welded, cut or otherwise processed.

2. Description of the Prior Art

A laser processing apparatus conventionally comprises a laser radiation source, which can be, for example, an Nd:YAG laser, a fibre laser, a disk laser or a CO₂ laser. A laser processing apparatus further includes a processing head, which focuses the laser radiation generated by the laser radiation source in a focal spot. A beam guidance system guides the laser radiation generated by the laser radiation source to the processing head. Especially when the laser radiation has a relatively lower beam quality, it is generally guided to the processing head as a collimated beam with a relatively large diameter (20 mm to 100 mm). For deflecting the laser radiation, deflecting mirrors with planar or curved surfaces are mostly provided. The processing head can be fastened to a movable robotic arm, while the laser radiation source is located outside the robot.

For focusing the laser radiation in a focal spot, the processing head generally contains focusing optics. In particular when the focusing optics contain lenses and other light-permeable optical elements such as protective shields, the unavoidable residual absorption into the optical materials used has the result that the elements heat up. This is accompanied by a change in shape due to thermal expansion. Thus, even protective shields which act optically as plane-parallel plates at room temperature can have a collecting action after heating.

The refractive power of the optical elements in question changes as a result of heating, and this has an effect on the shape and especially on the axial position of the focal spot produced by the focusing optics. Owing to the unintentional displacement of the focal spot, the workpieces can no longer be processed in the desired manner.

In order to be able to keep the location and the shape of the focal spot constant during operation of the laser processing apparatus, the changes to the focal spot must on the one hand be detected by measurement. In a second step, optical elements must be readjusted in such a manner that they compensate for the thermally induced changes in the focusing optics.

For detecting changes to the focal spot, it is known to direct measuring light, which can also be outcoupled laser radiation, onto the focusing optics and then detect it with light sensors. Examples thereof are described in JP S61-137693 A, JP H02-204701 A, EP 2 216 129 A1 and DE 10 2011 054 941 B3.

Adaptive mirrors are generally used to compensate for the displacements of the focal spot caused by the focusing optics. However, the deformation of an adaptive mirror by means of piezoelectric elements, as is disclosed in JP H02-204701 A already mentioned, is very complex. The same is true for adaptive mirrors which are in the form of facet mirrors and contain a plurality of individually controllable mirror facets. Here too, the structural and control-related demands are so high that they would not be economical to implement.

In order to compensate for the effects of thermally induced deformations in the focusing optics, there have therefore become established adaptive mirrors which have a mirror substrate which delimits a pressure chamber filled with a fluid, for example air or a liquid. The internal pressure in the pressure chamber can be changed by means of a pressure source. The mirror substrate is so thin that, together with an optional reflective coating carried thereon, it is deformed in dependence on the internal pressure in the pressure chamber.

Such adaptive mirrors are known from WO 2007/000 171 A1, DE 41 37 832 A1 and DE 198 32 343 A1. In those publications, the region of the mirror substrate delimiting the pressure chamber has a constant thickness. In addition, the mirror substrates therein are mounted at the periphery with a bearing value of one (i.e. in the manner of a floating bearing). This means that only one degree of freedom of movement is fixed by the mounting. In plane-parallel mirror substrates, mounting with a bearing value of one generally leads, at specific internal pressures, to almost spherical deformation in a central region of the mirror substrate. Spherical deformations are generally preferred because the axial position of the focal spot can thereby be kept constant with low aberrations.

However, these known adaptive mirrors also have some serious disadvantages. Mounting with a bearing value of one means that sealing of the pressure chamber with respect to the fluid is very complex in terms of construction. Moreover, such adaptive mirrors are frequently provided with a water cooling system, which leads to additional sealing problems.

A further disadvantage of the known adaptive mirrors is that the desired spherical deformation is achieved only in a relatively small central region despite the mounting with a bearing value of one. The adaptive mirror must therefore be relatively large for a given diameter of the laser radiation, in order to be able to compensate for thermally induced displacements of the focal spot in such a manner that unacceptable wave front deformations do not occur.

There is known from DE 39 00 467 A1 an adaptive mirror in which the thickness of the mirror substrate is not constant but decreases towards the centre. As a result of this thickness profile, it is possible to achieve almost Gaussian deformation with the mounting with a bearing value of one described therein.

### SUMMARY OF THE INVENTION

It is an object of the invention to provide an adaptive mirror for a laser processing apparatus which is deformed almost spherically over a large region but nevertheless is simple in terms of construction.

The object is achieved by an adaptive mirror for a laser processing apparatus having a housing, a pressure chamber which is arranged in the housing and opens into a connecting line which can be connected to a pressure source, and having a mirror substrate which delimits the pressure chamber and is fixedly clamped in the housing. An internal pressure in the pressure chamber can be changed by means of the pressure source in such a manner that the mirror substrate, optionally together with a reflective coating carried thereby, is deformed in dependence on the internal pressure in the pressure chamber. According to the invention, the mirror substrate has a stiffness which increases continuously or stepwise towards the geometric centre at least in a region surrounding the geometric centre of the mirror substrate.

The invention is based on the surprising finding that, in a mirror substrate that is not mounted with a bearing value of one but is fixedly clamped into the housing, almost spherical deformation is achieved when the stiffness of the mirror substrate increases over a region of the mirror substrate surrounding its geometric centre. Torsional moments which occur in the edge region owing to the mirror substrate's being mounted with a bearing value of three and which otherwise lead to aspherical deformation of the mirror substrate under pressure are compensated for by this thickness profile in such a manner that the mirror substrate is deformed spherically. The spherical deformation thereby takes place over a large proportion of the surface of the mirror substrate, so that up to 70% of the surface of the mirror substrate can be utilised optically. Because it is fixedly clamped into the housing, the adaptive mirror according to the invention can at the same time be very simple in terms of construction. The difficult sealing problems which are typical of mirror substrates mounted with a bearing value of one do not arise in the case of fixed clamping. This is true even when an additional water cooling system is provided for the mirror substrate.

The geometric centre of the mirror substrate is defined as an axis which passes through the geometric centre of a planar surface delimited by the periphery of the mirror substrate. In the case of a circular periphery, that axis runs through the centre of the circle, and in the case of an elliptical periphery it runs through the point at which the long and the short semi-axis of the ellipse intersect.

At least in the case of smaller mirror substrates, the mirror substrate can have a stiffness which increases towards the geometric centre in a closed region containing the geometric centre of the mirror substrate. In this case, the stiffness thus increases continuously from a circumferential line of said region, which can but does not necessarily have to coincide with the periphery of the mirror substrate, to the geometric centre of the mirror substrate.

Calculations have shown that, in the case of larger mirror substrates, the stiffness should not increase continuously towards the geometric centre. In the case of larger mirror substrates, spherical deformation is achieved only when the region surrounds a central region in which the stiffness is constant or even decreases towards the geometric centre.

The distribution according to the invention of the stiffness over the surface of the mirror substrate can be achieved in different ways. For example, the thickness of the mirror substrate can be constant and the locally varying stiffness can be created by generating a varying temperature distribution in the mirror substrate. Many materials, in particular metals such as steel or aluminium, have the property that their stiffness decreases after heating or increases following subsequent rapid cooling. If a specific temperature distribution is once generated in the mirror substrate before the adaptive mirror is assembled, the stiffness distribution is thereby changed permanently.

The desired distribution of the stiffness can be established more accurately if the locally varying stiffness is the result of a locally varying thickness of the mirror substrate. By applying the finite element method, it is possible to calculate a thickness profile for the mirror substrate which leads to a desired deformation. There are thereby specified in particular the modulus of elasticity of the material of which the mirror substrate is composed, the maximum deflection of the mirror substrate, the internal pressure of the pressure chamber at which the maximum deflection is to be achieved, and the outer outline of the mirror.

In the case of mirrors with a circular outer outline, the thickness profile will generally be rotationally symmetrical with respect to the geometric centre. However, adaptive mirrors are frequently used as deflecting mirrors which deflect the laser beam through 90°. A surface normal in the geometric centre of the adaptive mirror must then be arranged at an angle of 45° to the optical axis. When the laser radiation has a circular cross-section, it illuminates an elliptical area on a mirror arranged in that manner, the semi-axes of the ellipse being in a ratio of 1:\sqrt{2}

In such a case, the mirror substrate should also not be bordered in a circle but, in a plane in which it is clamped in the housing, should have maximum dimensions dₓ and d_{y}≠dₓ in orthogonal directions X and Y. When dₓ=1/\sqrt{2}·d_{y}, the periphery of the mirror substrate has an elliptical shape, which is optimal for deflecting the laser radiation through 90°.

In the case of elliptical mirror substrates, the stiffness in the region increases towards the geometric centre to differing degrees in directions X and Y. A mirror substrate with such a stiffness distribution is not deformed spherically when the internal pressure in the pressure chamber changes but in such a manner that at least a larger part of the surface of the mirror substrate assumes almost the shape of a toric section. The torus thereby has different circle radii in orthogonal directions. The larger circle radius is achieved in the direction of the longer semi-axis of the elliptical periphery. This larger circle radius takes account of the fact that, in this plane, the deflection of the optical axis takes place through 90°. The collecting or scattering action of the adaptive mirror on the deflected laser radiation is therefore the same in all directions, so that the action on the laser radiation is rotationally symmetrical with respect to the optical axis.

By purposively varying the stiffness of the mirror substrate in directions X and Y, a desired deviation from that rotational symmetry can be achieved. The adaptive mirror can then additionally correct an already existing astigmatism or can generate an astigmatism as an allowance, for example in order to compensate for the astigmatic action of an optical element which follows in the optical light path. The angle of incidence of the laser radiation occurring at the mirror and the mirror outline must thereby be matched to one another.

It is advantageous if, at precisely one internal pressure, the mirror substrate has a planar outer surface facing away from the pressure chamber and an inner surface facing towards the pressure chamber that has the form of a section of a surface of an ellipsoid. Such a shape of the inner surface leads to the above-mentioned differing spherical deformation of the mirror substrate in directions X and Y, as is generally desirable in the case of a deflecting mirror.

Because the production of an ellipsoid-shaped inner surface is complex, the mirror substrate can have, at precisely one internal pressure, a planar outer surface facing away from the pressure chamber and an inner surface facing towards the pressure chamber, the mirror substrate being stepped in a direction perpendicular to directions X and Y in such a manner that the inner surface has the approximate shape of a section of a surface of an ellipsoid. Such a stepped shape of the inner surface is easier to produce.

When the internal pressure at which the outer surface is planar is greater than normal pressure, a concave outer surface is obtained when the internal pressure in the pressure chamber falls to normal pressure. This has advantages in terms of control, because a pressure reduction is generally easier to establish starting not from normal pressure but from a pressure that is elevated compared with normal pressure.

The invention additionally provides a laser processing apparatus having a laser radiation source for generating laser radiation, a processing head, a beam guidance system, which is arranged in the optical path between the laser radiation source and the processing head, and an adaptive mirror according to the invention, which is connected to the pressure source and is arranged in the beam guidance system.

When the processing head contains focusing optics and a measuring system for measuring the focal length of the focusing optics during laser processing, the laser processing apparatus can have a control system for the adaptive mirror which is configured to control the adaptive mirror in dependence on measuring signals from the measuring system in such a manner that the adaptive mirror compensates for a change in the focal length of the focusing optics measured by the measuring system. Such changes in the focal length are generally undesirable and can in particular be thermally induced.

### BRIEF DESCRIPTION OF THE DRAWINGS

Further features and advantages of the invention will become apparent from the following description of exemplary embodiments with reference to the drawings, in which:

FIG. 1 shows a schematic side view of a laser processing apparatus according to the invention;

FIG. 2 shows a schematic representation of the optical path and the signal connections in the laser processing apparatus shown in FIG. 1;

FIGS. 3a and 3b show a conventional adaptive mirror, which is part of the laser processing apparatus shown in FIGS. 1 and 2, in a planar position and a concave position;

FIGS. 4a and 4b show an adaptive mirror according to the invention in a planar position and a concave position;

FIG. 5 shows a top view and two side views of a mirror substrate of the adaptive mirror according to the invention shown in FIGS. 4a and 4b;

FIG. 6 shows an alternative exemplary embodiment of a mirror substrate in a representation based on FIG. 5;

FIG. 7 shows a graph showing the deformation of the mirror substrate when fixedly clamped and when mounted with a bearing value of one for different pressure values in the pressure chamber;

FIG. 8 shows a graph illustrating the almost spherical deformation of the mirror substrate in a central region;

FIGS. 9 and 10 show further exemplary embodiments of mirror substrates according to the invention in a representation based on FIG. 5.

### DESCRIPTION OF PREFERRED EXEMPLARY EMBODIMENTS

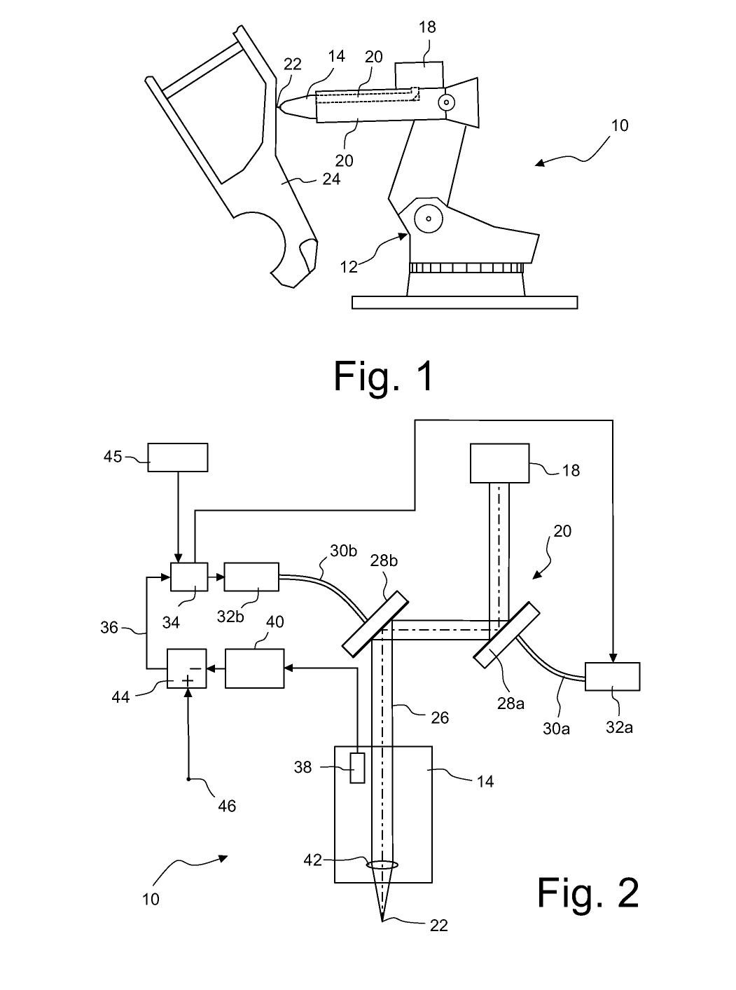

FIG. 1 shows a side view of a laser processing apparatus 10 having a robot 12 and a processing head 14 which is fastened to a movable arm 16 of the robot 12.

The laser processing apparatus 10 additionally includes a laser radiation source 18, which in the exemplary embodiment shown is in the form of an Nd:YAG laser or CO₂ laser. Other lasers and other arrangements of the laser radiation source 18 relative to the robot 12 are of course likewise possible. The laser radiation generated by the laser radiation source 18 is guided via a laser guidance system 20 to the processing head 14 and from there is focused in a focal spot 22. The arm 16 of the robot 12 is positioned with respect to a workpiece 24 in such a manner that the focal spot 22 is situated at the desired location on the workpiece 24 and the workpiece 24 can be processed by welding, separating or in another manner.

### 1. Beam Guidance System

FIG. 2 shows schematically the beam path of the laser radiation as well as further details of the laser guidance system 20 in a schematic representation. In the beam path of the laser radiation designated 26 between the laser radiation source 18 and the processing head 14 there are located a first adaptive mirror 28a and a second adaptive mirror 28b. The two adaptive mirrors 28a, 28b each deflect the laser radiation 26 through 90°. The spatial arrangement chosen here is merely by way of example; in real laser processing apparatuss, further deflecting mirrors, different spatial arrangements and also different angles of deflection can be provided.

The first adaptive mirror 28a is connected via a first pressure line 30a to a first pressure source 32a. The same is also true for the second adaptive mirror 28b, that is to say it is connected via a second pressure line 30b to a second pressure source 32b.

The two pressure sources 32a, 32b are controlled by a common control system 34. Measuring signals which are generated by a measuring system 38 and processed by an evaluation system 40 associated therewith are fed to the control system 34 via a signal line 36. The measuring system 38 is arranged in the processing head 14 and measures the focal length of focusing optics contained in the processing head 14 and indicated in FIG. 2 by a single lens 42. The focal length of the focusing optics can change during operation of the laser processing apparatus 10 when the lens 42 heats up as a result of absorbing some of the laser radiation 26 and thereby changes shape.

Examples of a suitable measuring system 38 will be found in EP 2 216 129 A1 and DE 10 2011 054 941 B1. A particularly suitable measuring system 38 is described in a patent application filed on the same day by Marius Jurca and entitled “Processing head for a laser processing apparatus and method for measuring changes in the focal length of focusing optics contained therein”.

The measured values generated by the measuring system 38 are converted by the evaluation system 40 into values for the focal length and compared with a desired value 46 for the focal length in a comparator 44. There are accordingly supplied to the control system 34, via the signal line 36, measuring signals that reflect a deviation of the actual focal length of the focusing optics 42 from the desired value 46.

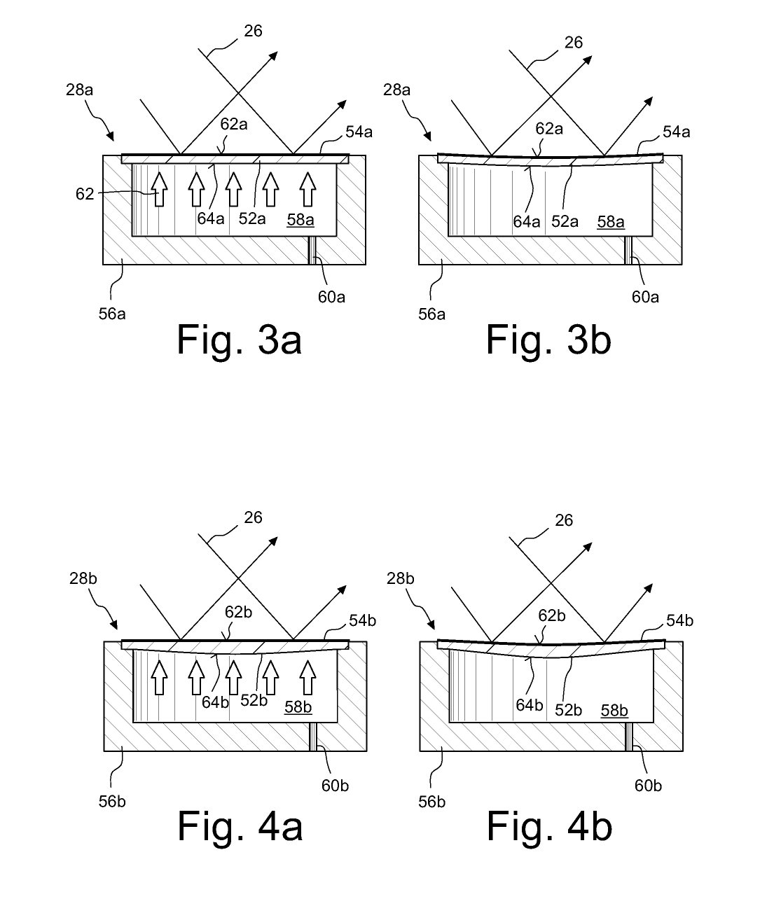

Before the interaction of the measuring system 38 with the adaptive mirrors 28a, 28b is described in greater detail, the construction of the adaptive mirrors 28a, 28b will first be explained in the following section in relation to FIGS. 3 and 4.

### 2. Construction of the Adaptive Mirrors

FIG. 3a shows the first adaptive mirror 28a in a first operating state, in which a mirror substrate 52a of the first adaptive mirror 28a is planar. In the exemplary embodiment shown, the mirror substrate 52a carries a reflective coating 54a, which can be, for example, an arrangement of a plurality of thin individual layers with varying refractive indices, as is known per se in the prior art. The mirror substrate 52a is fixedly clamped into a housing 56a along its entire periphery. As a result of this mounting, which is also referred to as a mounting with a bearing value of three, the mirror substrate 52a has no degree of freedom of movement with respect to the housing 56a and can be deformed under pressure only on the basis of its own elasticity.

Together with the housing 56a, the mirror substrate 52a delimits a pressure chamber 58a, into which there opens a connecting line 60a. The first pressure line 30a is connected to the connecting line 60a, so that the pressure chamber 58a is in fluid communication with the first pressure source 32a.

In the operating state shown in FIG. 3a, the internal pressure in the pressure chamber 58a is elevated as compared with the normal pressure prevailing outside the pressure chamber 58a. This is indicated in FIG. 3a by arrows 62 directed towards the mirror substrate 52a. This is intended to show that compressive forces are acting on the mirror substrate 52a which generate bending moments in the mirror substrate 52a.

In the exemplary embodiment shown, the mirror substrate 52a is so formed that, under elevated internal pressure in the pressure chamber 58a, it has a planar outer surface 62a which faces away from the pressure chamber 58a and carries the reflective coating 54a. Because the mirror substrate 52a has a constant thickness over its entire surface, the inner surface 64a facing towards the pressure chamber 58a is also planar under this internal pressure.

If the pressure in the pressure chamber 58a falls to normal pressure, then the mirror substrate 52a bends in a concave manner, as is illustrated in FIG. 3b. The adaptive mirror 28a thereby acquires a collecting optical action.

FIGS. 4a and 4b show cross-sections through the second adaptive mirror 28b under elevated internal pressure and normal pressure. In contrast to the first adaptive mirror 28a, the mirror substrate 52b of the second adaptive mirror 28b has a specifically defined thickness distribution. In the exemplary embodiment shown, the thickness increases continuously from the edge of the mirror substrate 52b, which is fixedly clamped into the housing 56b, to the geometric centre of the mirror substrate 52b. If the internal pressure in the pressure chamber 58b falls to normal pressure, as is illustrated in FIG. 4b, the mirror substrate 52b is likewise deformed in a concave manner. In contrast to the first adaptive mirror 28a, however, this deformation is almost spherical over a larger surface, even in the case of greater deformations. Such greater deformations are required in order to be able to compensate for thermally induced focal length changes of the focusing optics 42 during operation of the laser processing apparatus 10. As will be explained in greater detail below, the first adaptive mirror 28a merely has to correct relatively small divergence variations of the laser radiation 26 at the output of the laser radiation source 18, which is possible with substantially smaller deformation strokes.

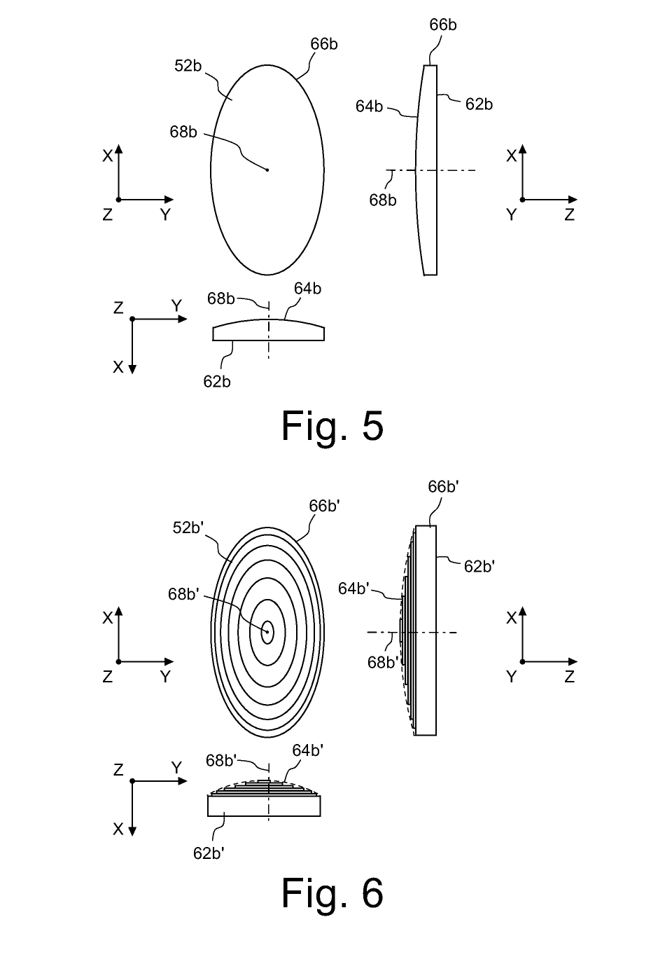

FIG. 5 shows a top view and two side views of the mirror substrate 52b of the second adaptive mirror 28b in the operating state shown in FIG. 4a, in which the outer surface 62b is planar. The reflective coating on the outer surface 62b is not shown in FIG. 5.

It will be seen that the inner surface 64b facing towards the pressure chamber 58a has the shape of a section of a surface of an ellipsoid. Because the stiffness of the mirror substrate 52b is directly proportional to the thickness, the stiffness of the mirror substrate 52b thus also increases continuously from the periphery 66b to the geometric centre 68b of the mirror substrate 52b. The increase in the stiffness from the periphery 66b to the geometric centre 68b is smaller in the X-direction, which extends along the long semi-axis of the elliptical periphery 66b, than in direction Y, which extends along the short semi-axis.

A similar increase in the stiffness is achieved if, instead of the continuous thickness profile as is shown in FIG. 5, a stepped thickness profile is used, as is shown in FIG. 6. In the state shown in FIG. 4a with elevated internal pressure, the outer surface 62b′ is planar here too. The inner surface 64b′, on the other hand, is stepped in direction Z, which runs perpendicular to directions X and Y, in such a manner that the inner surface 64b′ has the approximate shape of a section of a surface of an ellipsoid. The inner surface 64b′ is thus easier to produce.

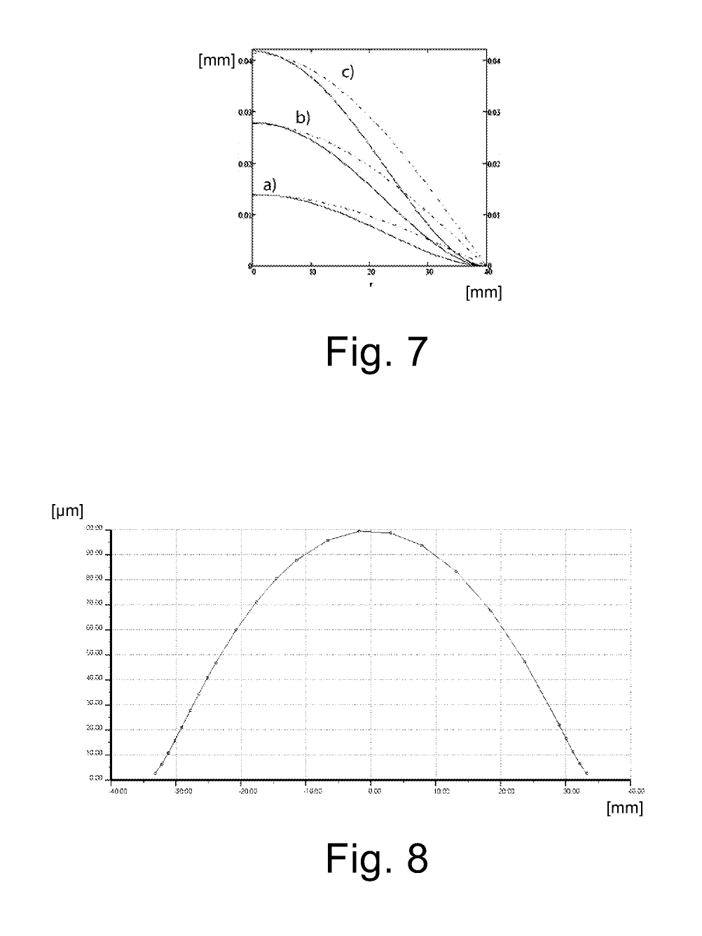

The advantages of the thickness profile of the mirror substrate 52b shown in FIGS. 4 to 6 will be explained in greater detail in the following with reference to FIGS. 7 and 8. FIG. 7 shows a graph in which, for three different internal pressures a), b) and c), the deformation of the plane-parallel mirror substrate 52a of the first adaptive mirror 28a is shown in millimetres for a half space. The solid lines represent the case of fixed clamping, as is chosen for the two adaptive mirrors 28a, 28b. For comparison, broken lines indicate the deformation when such a plane-parallel mirror substrate is mounted with a bearing value of one.

It will be seen that the approximation to a spherical deformation in the case of mounting with a bearing value of one (broken line) is possible over a larger region, particularly at high internal pressures (see pair of lines c)), than in the case of fixed clamping at the periphery. If large deformation strokes are to be possible, the entire surface of the mirror substrate must therefore be greater in the case of mounting with a bearing value of three (i.e. fixed clamping) than in the case of mounting with a bearing value of one.

However, owing to the thickness profile according to the invention, as is shown in FIGS. 4 to 6, the mirror substrate 52b of the second adaptive mirror 28b is deformed—despite the fixed clamping—like a mirror substrate with plane-parallel surfaces mounted with a bearing value of one, except that the spherical approximation applies over an even greater proportion of the surface. FIG. 8 shows the deformation of the mirror substrate 52b of the second adaptive mirror 28b for a specific internal pressure. It will be noted that the deformation (vertical axis) is given in micrometres and the distance from the centre along the long ellipse axis (horizontal axis) is given in millimetres. The region over which the mirror substrate 52b is deformed in the manner of an arc in this cutting plane is approximately 70%.

Accordingly, because of the fixed clamping, the second adaptive mirror can be of very simple construction and of small size. Nevertheless, almost spherical deformation with large deformation strokes is possible.

Where spherical deformation is mentioned above, this applies in the exemplary embodiment shown in FIGS. 4 to 6, strictly speaking, only in one of directions X or Y. Owing to the elliptical shape of the mirror substrate 52b and the non-rotationally symmetrical stiffness distribution, the mirror substrate 52b is deformed to a lesser degree in direction X than in direction Y. However, the deformation is spherical over a larger region of the mirror substrate 52b in both directions, but the curvatures are different from one another in directions X and Y. Because, in simple terms, the laser radiation 26 is distributed in direction X over a larger surface of the mirror substrate 52b when the deflection takes place in the XZ plane, the focusing action of the adaptive mirror in the concave state of the mirror substrate 52b shown in FIG. 4b is the same for directions X and Y.

By purposively varying the thickness profile in directions X and Y, a rotationally symmetrical action can also be achieved, for example in order to correct or purposively introduce an astigmatism.

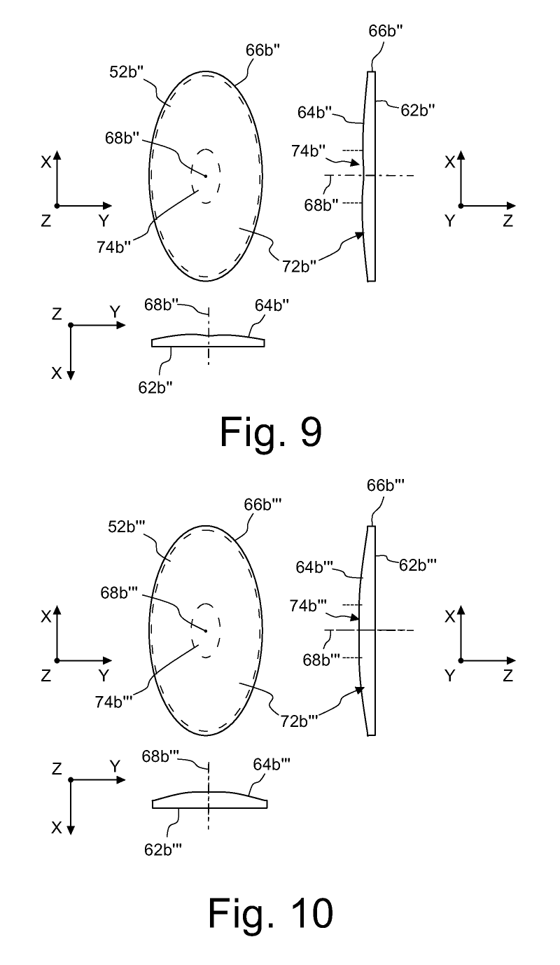

Calculations have shown that, in the case of particularly large mirror substrates, the stiffness should not increase to the geometric centre of the mirror substrate. FIG. 9 shows an exemplary embodiment of such a larger mirror substrate 52b″. Its thickness, and accordingly also its stiffness, increases only in a region 72b″, which surrounds but does not contain the geometric centre 68b″. Within a central region 74b″ which is surrounded by the region 72b″ and contains the geometric centre 68b″, the stiffness decreases again to the geometric centre 68b″.

The exemplary embodiment of a mirror substrate 52b′″ shown in FIG. 10 differs from the exemplary embodiment shown in FIG. 9 only in that the thickness, and accordingly also to stiffness, is constant in the central region 74b′″.

### 3. Control

In the following, reference is again made to FIG. 2 in order to describe the control of the adaptive mirrors 28a, 28b. The first adaptive mirror 28a is arranged immediately after the laser radiation source 18, and its function is to keep the cross-section of the laser radiation 26 constant as it strikes the second adaptive mirror 28b. This cross-section can vary during the laser processing if the optical distance between the adaptive mirrors 28a, 28b changes as a result of displacement movements of the robot 12. Changes in the optical distance between the adaptive mirrors 28a, 28b are therefore communicated to the control system 34 by a higher-level machine control system 45. This controls the pressure source 32a associated with the first adaptive mirror in such a manner that the cross-section of the laser radiation 26 on the second adaptive mirror 28b remains constant despite the changed distance.

Because a deformation of the first adaptive mirror 28a also has an effect on the axial position of the focal spot 22, this must be compensated for by actuating the second adaptive mirror 28b, which is generally arranged immediately in front of the processing head 14, in order to compensate for the displacement of the focal spot introduced by the first adaptive mirror 30a. The control system 34 therefore at the same time also controls the second adaptive mirror 28b, it being possible for a different deformation stroke to be specified.

If the measuring system 38 in the processing head 14 detects a change in the focal length of the focusing optics 42, greater deformation strokes of the second adaptive mirror 28b are generally required to compensate for this change in focal length. The deviations from the desired position of the focal spot 22 that are supplied via the signal line 36 are therefore converted in the control system 34 into control signals for the second pressure source 32b, which are additively superposed on any control signals derived by the control system 34 from changes in the optical distance between the adaptive mirrors 28a, 28b. Such changes in the optical distance accordingly always bring about (smaller) deformations of the two adaptive mirrors 28a, 28b, while changes in the focal length of the focusing optics 42 detected by the measuring system 38 lead to an additional control of the second adaptive mirror 28b with frequently greater deformation strokes.

In this manner, an axially constant position of the focal spot 22 can be achieved over all operating states. By purposively modifying the thickness profile of the mirror substrate 52b arranged in the second adaptive mirror 28b, it is additionally possible to correct astigmatism and other rotationally symmetrical aberrations. The shape of the focal spot 22 can thereby also better be kept constant.

1-12. (canceled)

13. An adaptive mirror for a laser processing apparatus, comprising
a housing;
a pressure chamber arranged in the housing and connected to a connecting line which is configured to be connected to a pressure source;
a mirror substrate which has a geometric centre, delimits the pressure chamber and is fixedly clamped in the housing, wherein the mirror substrate has a stiffness which increases towards the geometric centre at least in a region completely surrounding the geometric centre of the mirror substrate;
wherein the mirror substrate is configured such that it is deformed in response to a change of an internal pressure in the pressure chamber produced by the pressure source.

14. The adaptive mirror of claim 13, wherein the mirror substrate has a stiffness which increases towards the geometric centre in a region containing the geometric centre of the mirror substrate.

15. The adaptive mirror of claim 13, wherein the region surrounds a central region in which the stiffness is constant or decreases towards the geometric centre.

16. The adaptive mirror of claim 13, wherein the locally varying stiffness is a result of a locally varying thickness of the mirror substrate.

17. The adaptive mirror of claim 13, wherein the mirror substrate has maximum dimensions dx and dy in orthogonal directions X and Y in a plane in which it is clamped in the housing, wherein dx dy.

18. The adaptive mirror of claim 17, wherein a periphery of the mirror substrate has an elliptical shape.

19. The adaptive mirror of claim 17, wherein in the region the stiffness of the mirror substrate increases towards the centre differently in directions X and Y.

20. The adaptive mirror of claim 19, wherein in response to a change of the internal pressure in the pressure chamber, the mirror substrate is deformed in such a manner that at least part of the surface of the mirror substrate assumes the shape of a toric section.

21. The adaptive mirror of claim 18, wherein the mirror substrate has maximum dimensions dₓ and d_{y} in orthogonal directions X and Y in a plane in which it is clamped in the housing, wherein dₓ and d_{y}, and wherein at precisely one internal pressure the mirror substrate has a planar outer surface facing away from the pressure chamber and an inner surface facing towards the pressure chamber and having the shape of a section of a surface of an ellipsoid.

22. The adaptive mirror of claim 21, wherein the precisely one internal pressure is greater than normal pressure.

23. A laser processing apparatus comprising a laser radiation source for generating laser radiation, a processing head, a beam guidance system, which is arranged in an optical path between the laser radiation source and the processing head, a pressure source, and an adaptive mirror of claim 1 which is connected to the pressure source and is arranged in the beam guidance system.

24. The laser processing apparatus of claim 23, wherein the processing head contains focusing optics and a measuring system configured to measure the focal length of the focusing optics during laser processing, and wherein the laser processing apparatus comprises a control system for the adaptive mirror which is configured to control the adaptive mirror in dependence on measuring signals from the measuring system in such a manner that the adaptive mirror compensates for a change in the focal length of the focusing optics measured by the measuring system.
